(19) United States
(12) Patent Application Publication
(10) Pub. No.: US 2018/0144379 A1
(43) Pub. Date: May 24, 2018

(54) IMAGE FORMING APPARATUS AND SALES SUPPORT SYSTEM

(71) Applicants: KABUSHIKI KAISHA TOSHIBA, Tokyo (JP); TOSHIBA TEC KABUSHIKI KAISHA, Tokyo (JP)

(72) Inventor: Noboru Ogino, Sunto Shizuoka (JP)

(21) Appl. No.: 15/358,445

(22) Filed: Nov. 22, 2016

(51) Int. Cl. G06Q 30/06; G06Q 20/40; G06Q 20/34

(52) U.S. Cl. CPC G06Q 30/0601; G06Q 20/341; G06Q 20/401

(57) ABSTRACT

An image forming apparatus comprises a first communication section which is connected with a first communication apparatus used by a user who wants to purchase a commodity to be sold in a communicable manner and receives a first purchase instruction for instructing purchase of the commodity from the first communication apparatus; a display section which displays information relating to the commodity; an operation section which receives a second purchase instruction for instructing purchase of a commodity displayed on the display section; and a second communication section which transmits the first purchase instruction or the second purchase instruction to a sales support server which instructs a store clerk that a commodity to which the first purchase instruction or the second purchase instruction is carried out by the user is conveyed to a predetermined position.

### FIELD

Embodiments described herein relate generally to an image forming apparatus and a sales support system and methods associated therewith.

### BACKGROUND

In recent years, due to rise of non-store sales such as an internet shop, store sales are decreasing. However, fresh food and medicine are difficult to purchase and deliver in the internet shop setting. This is because that the fresh food and the medicine are restricted by freshness and the law. The improvement of sales in a retail store that sells fresh food and medicine is promoted through adding additional services such as printing of a recipe of bargains, printing of a coupon, a point back system based on a membership card, and the like. However, these services are services for a customer who physically enters the store. Thus, there is a problem of lacking services that function beneficially through the internet shop such as a specification investigation, price comparison, and commodity evaluation from a standpoint of the customer.

### DESCRIPTION OF THE DRAWINGS

FIG. 1 is a diagram illustrating an example of the whole configuration of a sales support system 1 according to an embodiment;

FIG. 2 is an external view illustrating an example of the whole configuration of an image forming apparatus 100 according to the embodiment;

FIG. 3 is a block diagram illustrating an example of the configuration of the image forming apparatus 100 according to the embodiment;

FIG. 4 is a block diagram illustrating an example of the configuration of a first communication apparatus 200 according to the embodiment;

FIG. 5 is a block diagram illustrating an example of the configuration of a sales support server 400 according to the embodiment;

FIG. 6 is a block diagram illustrating an example of the configuration of a second communication apparatus 700 according to the embodiment;

FIG. 7 is a diagram illustrating a concrete example of information displayed on a display 110 according to the embodiment;

FIG. 8 is a diagram illustrating a concrete example of a virtual space displayed on the first communication apparatus 200 according to the embodiment;

FIG. 9 is a sequence diagram illustrating a flow of a commodity purchase processing according to the embodiment;

FIG. 10 is a flowchart illustrating a flow of a commodity retrieval processing according to the embodiment; and

FIG. 11 is a sequence diagram illustrating a flow of an information delivery processing according to the embodiment.

### DETAILED DESCRIPTION

In accordance with an embodiment, an image forming apparatus comprises a first communication section, a display section, an operation section and a second communication section. The first communication section is connected with a first communication apparatus used by a user who wants to purchase a commodity to be sold in a communicable manner and receives a first purchase instruction which is an instruction for instructing purchase of the commodity from the first communication apparatus. The display section displays information relating to the commodity. The operation section receives a second purchase instruction which is an instruction for instructing purchase of the commodity displayed on the display section. The second communication section transmits the first purchase instruction or the second purchase instruction to a sales support server which instructs a store clerk that a commodity to which the first purchase instruction or the second purchase instruction is carried out by the user is conveyed to a predetermined position.

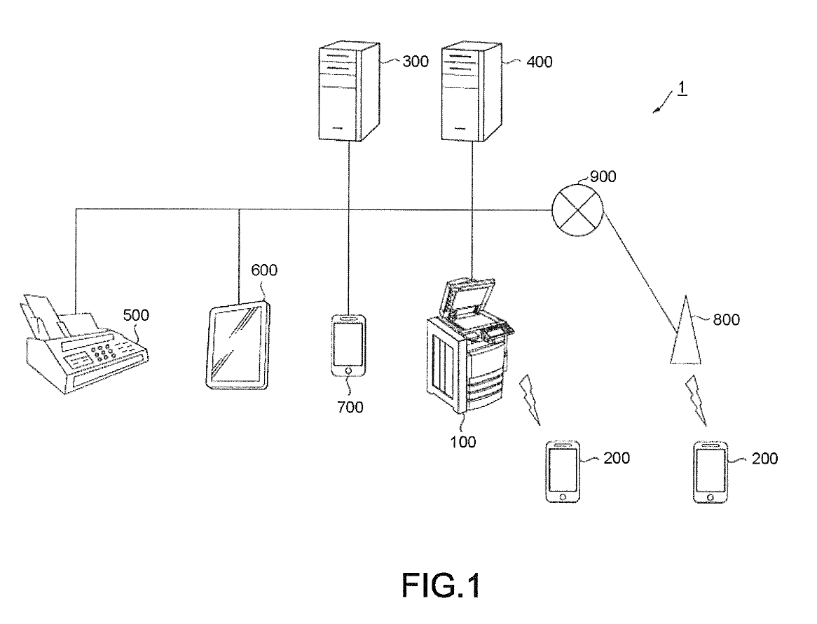

Hereinafter, an image forming apparatus of the embodiment is described with reference to the accompanying drawings. FIG. 1 is a diagram illustrating an example of the whole configuration of a sales support system 1 according to the embodiment. The sales support system 1 comprises an image forming apparatus 100, a first communication apparatus 200, a POS (Point Of Sale) server 300, a sales support server 400, a POS register 500, a display device 600, a second communication apparatus 700, abase station apparatus 800 and a network 900.

The image forming apparatus 100 is, for example, a multi-function peripheral. The image forming apparatus 100 forms an image on a sheet using a developer such as toner. The sheet is, for example, a paper or a label paper. The sheet may be optional as long as the image processing apparatus 100 can form an image on the surface thereof.

The first communication apparatus 200 is, for example, a portable terminal such as a tablet computer, a personal computer or a smart phone. The first communication apparatus 200 is held by a customer who enters a retail store. The first communication apparatus 200 executes various processing based on operations by the customer. Various processing include, for example, purchase of a commodity and reception of commodity information. The commodity information relates to the commodity sold in the retail store. The commodity information includes, for example, a commodity image, a commodity code, a display place, a commodity name and a sales price.

The POS server 300 manages information necessary for store jobs such as inventory information and sales information. The POS server 300 updates the inventory information and the sales information based on a result of a checkout processing received from the POS register 500. The inventory information indicates inventory number of the commodities. The sales information indicates total amount of sales amount of the retail store. The sales information is shown, for example, by a unit of period such as daily, weekly or monthly.

The sales support server 400 manages various information used in the sales support system 1. The sales support server 400 manages, for example, customer information, commodity information, event information and virtual space information. The customer information includes, for example, customer identification information, customer-incoming date and time, purchase commodity, and payment amount. The event information is information relating to an event held by the retail store such as an arrangement time of a sampling corner, a start time of a time sale. The virtual space information is information for constituting a virtual space used to realize the communication between the customer and the retail store. Specifically, the virtual space information is composed of a program constituting the virtual space, evaluation on a commodity from a customer and a response to the evaluation from the retail store. The virtual space is accessed from the first communication apparatus 200 via the base station apparatus 800.

The POS register 500 carries out the checkout processing to a commodity (hereinafter, referred to as a “purchase commodity”) purchased by the customer based on an operation by a store clerk or the customer. The POS register 500 transmits the result of the checkout processing to the POS server 300. The result of the checkout processing includes a checkout time, a purchase list, a payment amount and the like. The checkout time indicates time at which the checkout of the purchase commodity is completed. The purchase list indicates a list of purchase commodities in one transaction. The payment amount indicates a total amount of purchase commodities paid by the customer.

The display device 600 is an image display device such as a liquid crystal display, an organic EL (Electro Luminescence) display and the like. The display device 600 is arranged in premises of the retail store. The display device 600 displays information such as guidance for designating a register at which the customer stands to a customer or a store clerk.

The second communication apparatus 700 is, for example, a portable terminal such as a table computer, a personal computer or a smart phone. The second communication apparatus 700 is held by the store clerk of the retail store. The second communication apparatus 700 displays instruction information to the store clerk. The instruction information is used to, for example, notify the store clerk of where to convey the commodity.

The base station apparatus 800 is, for example, a mobile phone base station supplied by a communication carrier. The first communication apparatus 200 is connected with the sales support system 1 in a communicable manner via the base station apparatus 800.

The network 900 may be constituted by any kind of network. For example, the network 900 is constituted by internet.

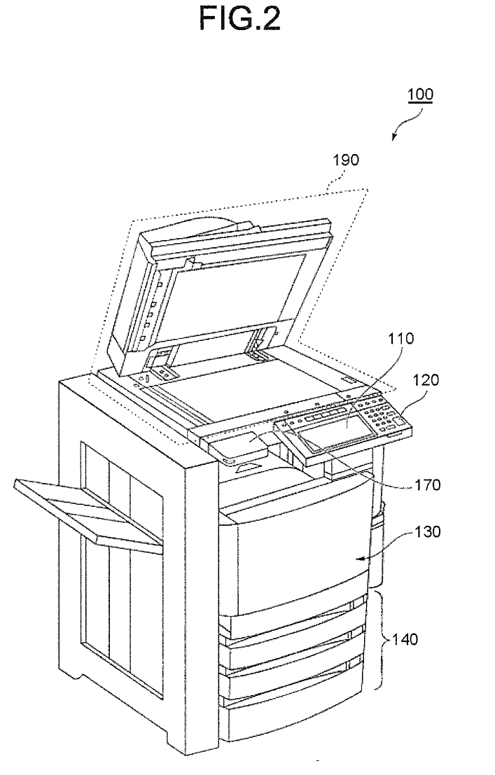

FIG. 2 is an external view illustrating an example of the whole configuration of the image forming apparatus 100 according to the embodiment.

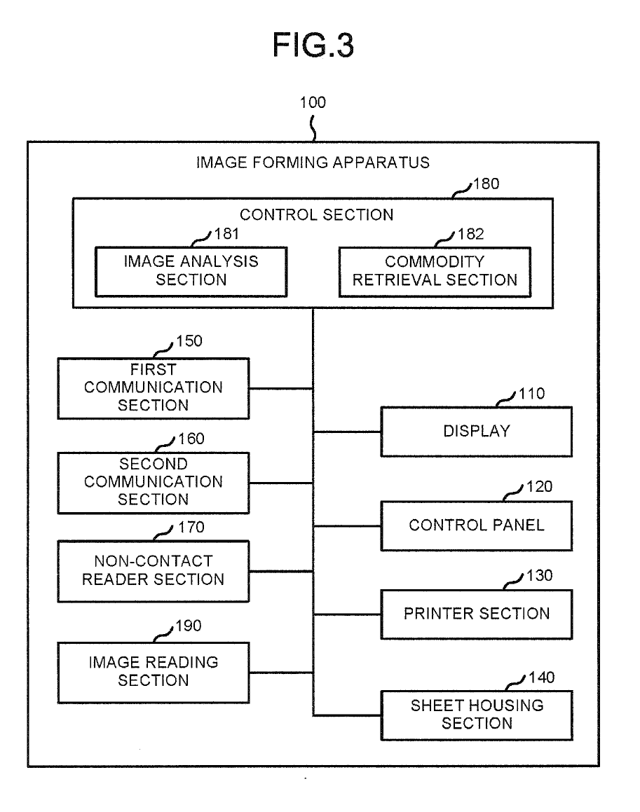

FIG. 3 is a block diagram illustrating an example of the configuration of the image forming apparatus 100 according to the embodiment. The image forming apparatus 100 is equipped with a display 110, a control panel 120, the printer section 130, a sheet housing section 140, a first communication section 150, a second communication section 160, a non-contact reader section 170, a control section 180 and an image reading section 190. The control section 180 is equipped with an image analysis section 181 and a commodity retrieval section 182. Further, the printer section 130 of the image forming apparatus 100 may be a device for fixing a toner image, or an inkjet type device.

The display 110 is an image display device such as a liquid crystal display, an organic EL display and the like. The display 110 displays various information relating to the image forming apparatus 100. The display 110 displays, for example, hot-selling commodities and the inventory number. The inventory number may be displayed in percentage. The display 110 may be an external display connected with the image forming apparatus 100. In this case, the display 110 functions as a connection interface with the external display.

The control panel 120 includes a plurality of buttons. The control panel 120 receives an operation by the user. The control panel 120 outputs a signal in response to the operation executed by the user to the control section 180 of the image forming apparatus 100. Further, the display 110 and the control panel 120 may be constituted as an integrated touch panel.

The printer section 130 forms an image on the sheet based on image information generated by the image reading section 190 or image information received through a communication path. The printer section 130 forms an image through the following processing, for example. An image forming section of the printer section 130 forms an electrostatic latent image on a photoconductive drum based on the image information. The image forming section of the printer section 130 forms a visible image by attaching the developer to the electrostatic latent image. Toner is exemplified as a concrete example of the developer. A transfer section of the printer section 130 transfers the visible image onto the sheet. A fixing section of the printer section 130 fixes the visible image on the sheet by heating and pressurizing the sheet. The sheet on which the image is formed may be a sheet housed in the sheet housing section 140, or a sheet that is manually fed.

The sheet housing section 140 houses the sheet used in the image formation by the printer section 130.

The first communication section 150 is a network interface. The first communication section 150 communicates with the first communication apparatus 200 and the second communication apparatus 700 using a wireless communication. The wireless communication is, for example, iBeacon® Technology or Bluetooth® Technology.

The second communication section 160 is a network interface. The second communication section 160 communicates with the sales support server 400 and the network 900 through a wired communication or a wireless communication. The wired communication is, for example, an ISDN (Integrated Services Digital Network) line, an ADSL (Asymmetric Digital Subscriber Line) line or an optical line. The wireless communication is, for example, a wireless LAN (Local Area Network) and the like.

The non-contact reader section 170 carries out reading of data from an IC card using a wireless communication. The wireless communication is, for example, a RFID (Radio Frequency Identifier), a NFC (Near Field Communication) and the like.

The IC card is used to identify a customer. The IC card records the customer identification information. The IC card is held over the non-contact reader section 170 to read the customer identification information. The IC card is held by a customer who enters the retail store.

The control section 180 controls operations of each section of the image forming apparatus 100. The control section 180 is a device including a CPU (Central Processing Unit) and a RAM (Random Access Memory). The control section 180 functions as the image analysis section 181 and the commodity retrieval section 182 through executing a commodity retrieval program.

The image analysis section 181 executes an image analysis processing to the image information read by the image reading section 190. The image analysis section 181 outputs character information and image information serving as the results of the image analysis processing to the commodity retrieval section 182. The image analysis processing is, for example, an OCR (Optical Character Recognition).

The commodity retrieval section 182 executes a commodity retrieval processing based on the analyzed image information. The commodity retrieval processing may be, for example, CBIR (Content Based Image Retrieval) or TBIR (Text Based Image Retrieval). The commodity retrieval processing may be any other retrieval processing. The commodity retrieval section 182 acquires the commodity information specified by the commodity retrieval processing from the sales support server 400. The commodity retrieval section 182 may acquire a plurality of the commodity information from the sales support server 400. The commodity retrieval section 182 outputs the commodity information to the display 110. The commodity retrieval section 182 may output the commodity information to the printer section 130. In a case in which the commodity retrieval section 182 outputs a plurality of the commodity information to the printer section 130, a plurality of the commodity information may be output in such a manner that the plurality of the commodity information is used to form images on one sheet. The commodity retrieval section 182 may transmit the commodity information to the first communication apparatus 200.

The image reading section 190 reads the image information which is a reading object as intensity of light. The image reading section 190 records the read image information. The recorded image information may be transmitted to other information processing apparatus via a network. The recorded image information may be used to form an image on the sheet through the printer section 130.

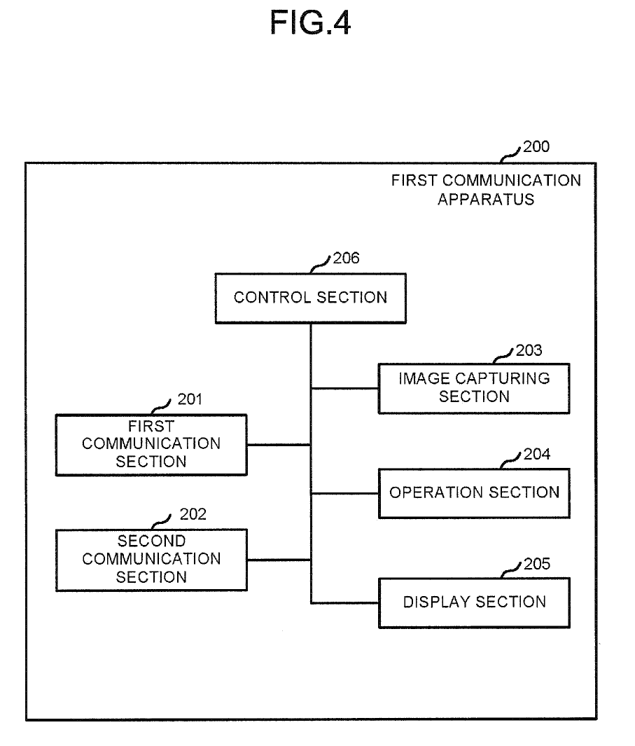

FIG. 4 is a block diagram illustrating an example of the configuration of the first communication apparatus 200 according to the embodiment. The first communication apparatus 200 is equipped with a first communication section 201, a second communication section 202, an image capturing section 203, an operation section 204, a display section 205 and a control section 206. Those sections included in the first communication apparatus 200 are connected via internal buses to be capable of executing data input and output mutually.

The first communication section 201 is a network interface. The first communication section 201 communicates with the image forming apparatus 100 using a wireless communication. The wireless communication is, for example, iBeacon or Bluetooth.

The second communication section 202 is a network interface. The second communication section 202 communicates with the base station apparatus 800 using a wireless communication. The wireless communication is, for example, electric wave of a mobile phone such as 3G or 4G.

The image capturing section 203 is an image capturing device such as a camera which is built in the first communication apparatus 200. The image capturing section 203 transmits captured images to the image forming apparatus 100.

The operation section 204 includes a plurality of buttons. The operation section 204 receives various operations by the user. The operation is, for example, a purchase instruction of the commodity. The operation section 204 transmits a signal in response to the operation executed by the user to the image forming apparatus 100. Further, the operation section 204 and the display section 205 may be constituted as an integrated touch panel.

The display section 205 is an image display device such as a liquid crystal display, an organic EL display and the like. The display section 205 displays various kinds of information relating to the first communication apparatus 200.

The control section 206 controls operations of each section of the first communication apparatus 200. The control section 206 is, for example, a device including a CPU and a RAM. The control section 206 executes a sales support program. The sales support program includes the customer identification information. The customer identification information is used to distinguish a customer from other customers. The customer identification information may be, for example, a MAC address of the first communication apparatus 200 or a random character string that is assigned to each sales support program. The customer identification information may be optional as long as the information can be used to distinguish the first communication apparatus 200 from other first communication apparatuses 200.

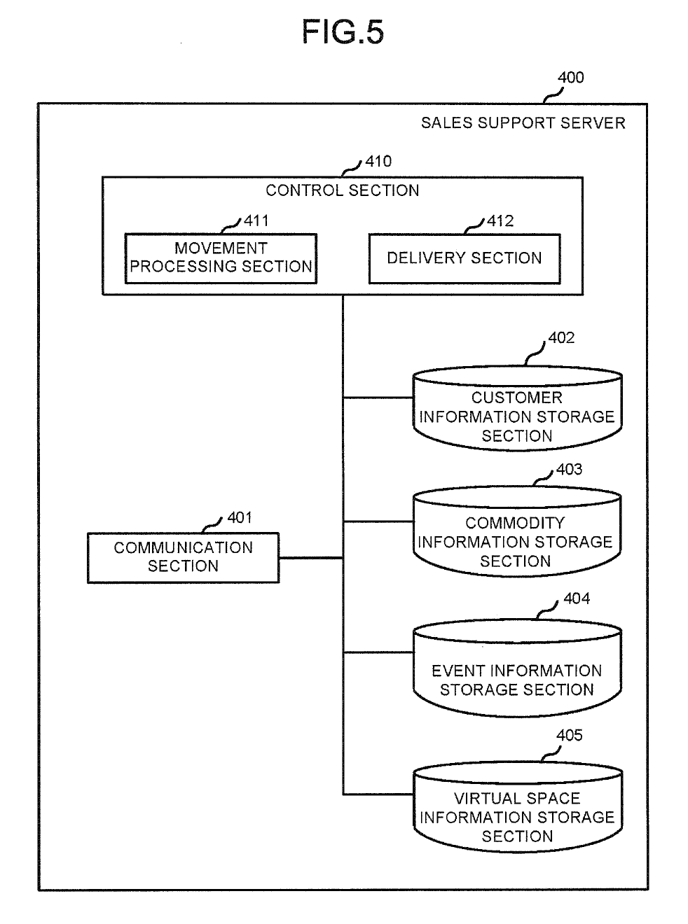

FIG. 5 is a block diagram illustrating an example of the configuration of the sales support server 400 according to the embodiment. The sales support server 400 is equipped with a communication section 401, a customer information storage section 402, a commodity information storage section 403, an event information storage section 404, a virtual space information storage section 405 and a control section 410. The control section 410 is equipped with a movement processing section 411 and a delivery section 412.

The communication section 401 is a network interface. The communication section 401 communicates with the image forming apparatus 100 and the POS server 300 through a wired communication or a wireless communication. The wired communication is, for example, an optical line. The wireless communication is, for example, a wireless LAN and the like.

The customer information storage section 402 is a storage device such as a magnetic hard disk device or a semiconductor memory device. The customer information storage section 402 stores the customer information.

The commodity information storage section 403 is a storage device such as a magnetic hard disk device or a semiconductor memory device. The commodity information storage section 403 stores the commodity information.

The event information storage section 404 is a storage device such as a magnetic hard disk device and a semiconductor memory device. The event information storage section 404 stores the event information to be held at the retail store.

The virtual space information storage section 405 is a storage device such as a magnetic hard disk device and a semiconductor memory device. The virtual space information storage section 405 stores the virtual space information.

The control section 410 controls operations of each section of the sales support server 400. The control section 410 is, for example, a device including a CPU and a RAM. The control section 410 functions as the movement processing section 411 and the delivery section 412 through executing the sales support program.

The movement processing section 411 executes a movement processing of the commodity. In particular, the movement processing section 411 receives a commodity purchase instruction from the image forming apparatus 100. The commodity purchase instruction is used to communicate that a customer purchases a commodity. The commodity purchase instruction includes information for identifying the commodity purchased by the customer. The movement processing section 411 determines a movement destination (for example, register) of the commodity. The movement processing section 411 transmits a commodity movement instruction to the second communication apparatus 700. The commodity movement instruction is used to communicate a message for moving the commodity to the movement destination to an owner of the second communication apparatus 700. The movement processing section 411 transmits a display instruction to the display device 600. The display instruction instructs to display a message for communicating a reception destination of the commodity to the customer who purchases the commodity.

The delivery section 412 generates data having added value (hereinafter, referred to as “value data”) and delivers the value data to the first communication apparatus 200. The value data supplies value to the customer. The value data is the event information that is held at the retail store, for example. The value data is information relating to the commodity that is discounted, for example. The value data may be any kind of information as long as it supplies value to the customer. The delivery section 412 generates the value data based on the customer information, the event information and the commodity information. The delivery section 412 is one form of a transmission section.

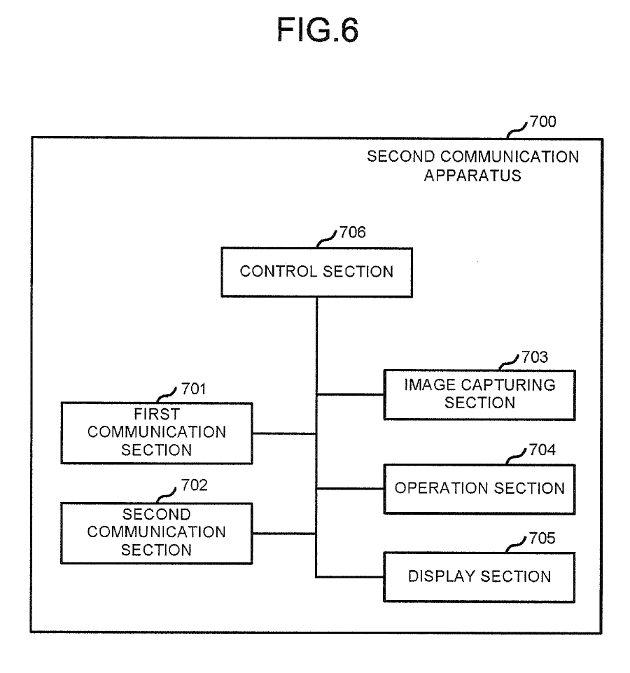

FIG. 6 is a block diagram illustrating an example of the configuration of the second communication apparatus 700 according to the embodiment. The second communication apparatus 700 is equipped with a first communication section 701, a second communication section 702, an image capturing section 703, an operation section 704, a display section 705 and a control section 706. Those sections included in the second communication apparatus 700 are connected via internal buses to be capable of executing data input and output mutually.

The first communication section 701 is a network interface. The first communication section 701 communicates with the image forming apparatus 100 using a wireless communication. The wireless communication is, for example, iBeacon or Bluetooth.

The second communication section 702 is a network interface. The second communication section 702 communicates with the base station apparatus 800 using a wireless communication. The wireless communication is, for example, electric wave of a mobile phone such as 3G or 4G.

The image capturing section 703 is an image capturing device such as a camera which is built in the second communication apparatus 700.

The operation section 704 includes a plurality of buttons. The operation section 704 receives various operations by the user. Further, the operation section 704 and the display section 705 may be constituted as an integrated touch panel.

The display section 705 is an image display device such as a liquid crystal display, an organic EL display and the like. The display section 705 displays various kinds of information relating to the second communication apparatus 700.

The control section 706 controls operations of each section of the second communication apparatus 700. The control section 706 is, for example, a device including a CPU and a RAM. The control section 706 executes the sales support program.

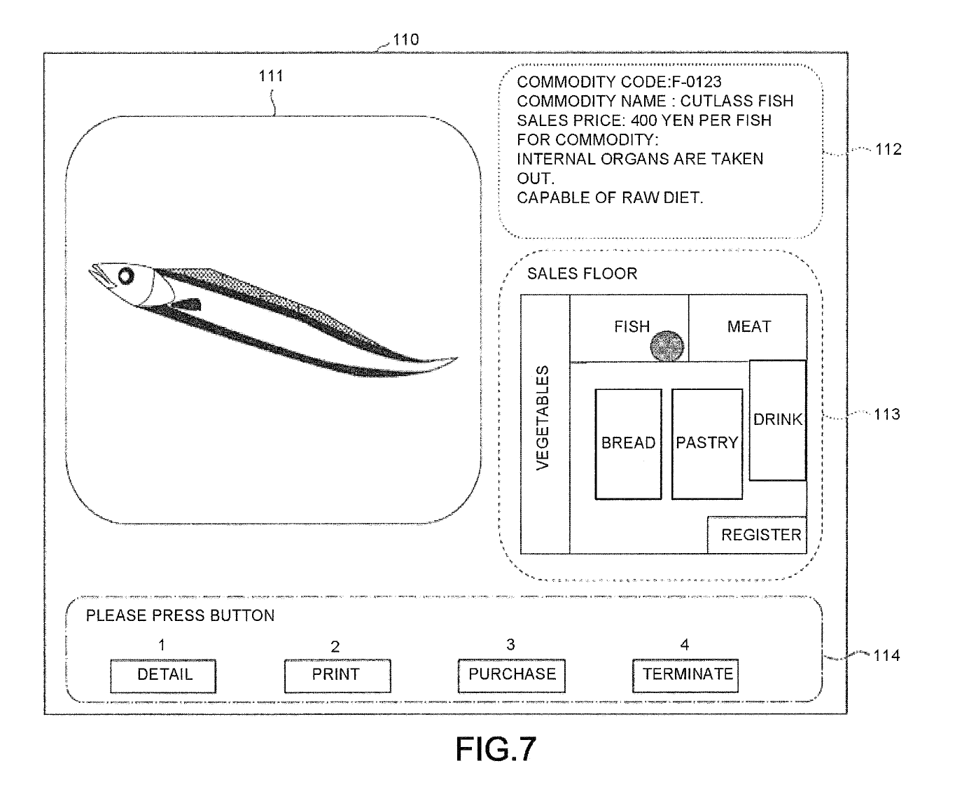

FIG. 7 is a diagram illustrating a concrete example of information displayed on the display 110 according to the embodiment. 111 in FIG. 7 is a commodity image of a commodity sold in the retail store. 112 in FIG. 7 is an image indicating the commodity information. 113 in FIG. 7 is an image indicating display place of the commodity. 114 in FIG. 7 is an image indicating an instruction to be received by the image forming apparatus 100. The instruction is received through operating the control panel 120. A “detail” is received through selecting a button 1. At this time, more detailed commodity information is displayed on the display 110. A “print” is received through selecting a button 2. At this time, the image information displayed on the display 110 is output to the printer section 130. A “purchase” is received through selecting a button 3. At this time, the commodity purchase instruction of the commodity displayed on the display 110 is transmitted to the sales support server 400. A “terminate” is received through selecting a button 4. At this time, the display of the commodity information on the display 110 is terminated. Further, the images shown in FIG. 7 are only concrete examples. Thus, images may be displayed in a form different from that shown in FIG. 7. For example, the image shown in FIG. 7 may include the evaluation displayed on the virtual space.

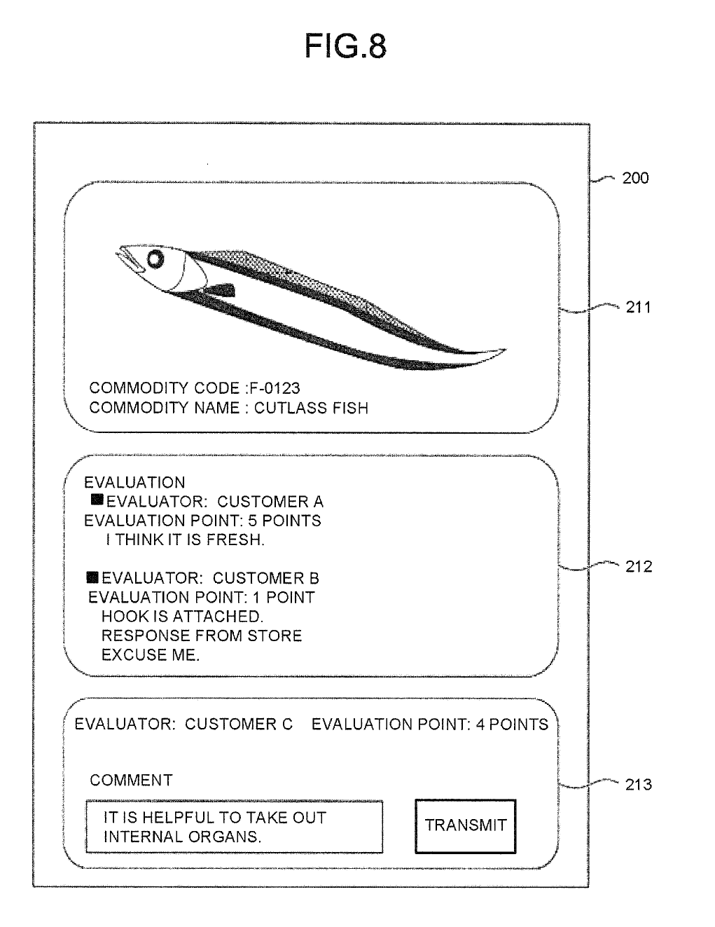

FIG. 8 is a diagram illustrating a concrete example of the virtual space displayed on the first communication apparatus 200 according to the embodiment. The commodity image and the commodity information are displayed in 211 in FIG. 8. Evaluation from the customer who purchases the commodity is displayed in 212 in FIG. 8. The evaluation contains an evaluator, an evaluation point and a comment. The retail store may respond to the evaluation. A window into which the customer inputs the evaluation is displayed in 213 in FIG. 8. The customer inputs an evaluator, an evaluation point and a comment through the operation section 204 and then selects “transmit”. Then, the input information is displayed in 212 in FIG. 8.

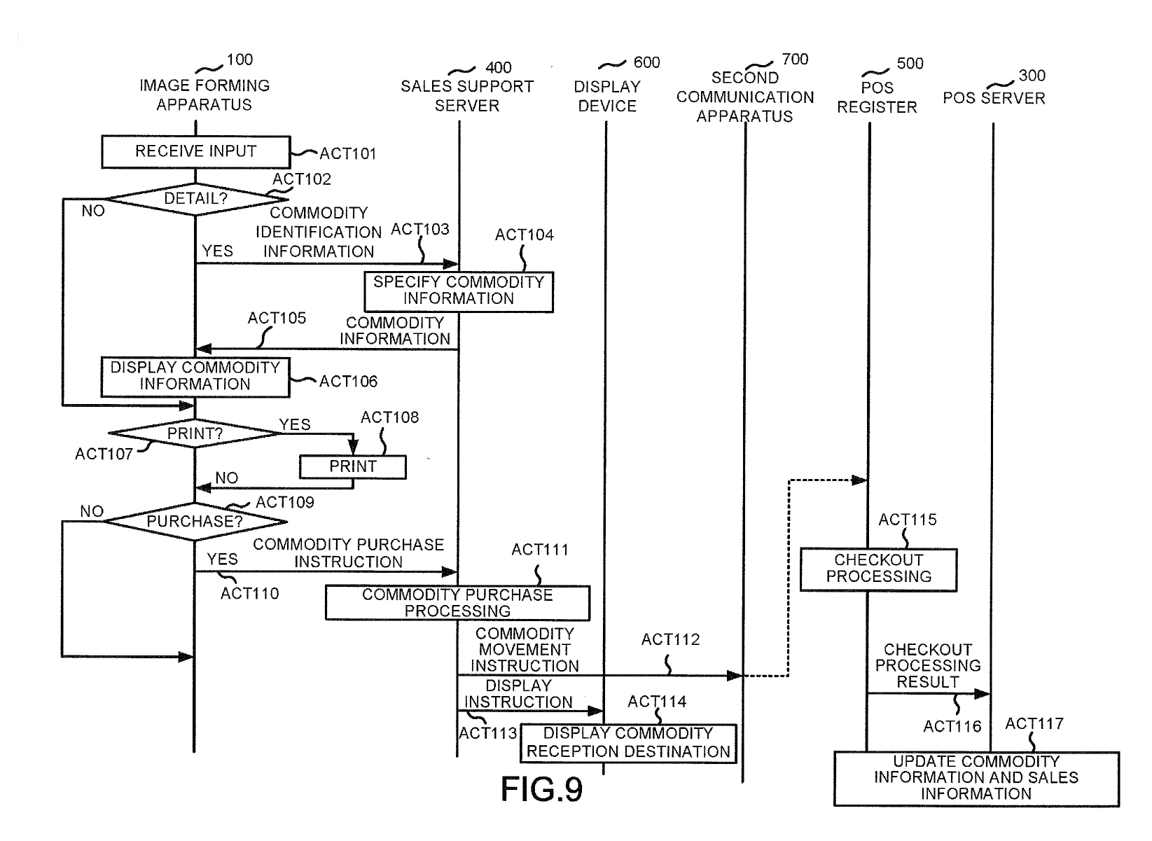

FIG. 9 is a sequence diagram illustrating a flow of a commodity purchase processing according to the embodiment. First, the image information relating to the commodity shown in FIG. 7 is displayed on the display 110 of the image forming apparatus 100. The control panel 120 of the image forming apparatus 100 receives input from the customer (ACT 101). The image forming apparatus 100 determines whether or not the received input is the “detail” (ACT 102). If it is determined that the received input is the “detail” (Yes in ACT 102), the image forming apparatus 100 transmits the information (hereinafter, referred to as “commodity identification information”) capable of identifying the commodity displayed on the display 110 to the sales support server 400 (ACT 103). The sales support server 400 specifies the commodity information corresponding to the commodity identification information from the commodity information storage section 403 (ACT 104). The sales support server 400 transmits the specified commodity information to the image forming apparatus 100 (ACT 105). The display 110 of the image forming apparatus 100 displays the commodity information (ACT 106). On the other hand, if it is determined that the input is not the “detail” (No in ACT 102), the image forming apparatus 100 proceeds to the processing in ACT 107.

Next, the image forming apparatus 100 determines whether or not the received input is the “print” (ACT 107). If it is determined that the input is the “print” (Yes in ACT 107), the printer section 130 forms an image on the sheet based on the image information displayed on the display 110. If it is determined that the input is not the “print” (No in ACT 107), the image forming apparatus 100 proceeds to the processing in ACT 109.

The image forming apparatus 100 determines whether or not the received input is the “purchase” (ACT 109). If it is determined that the input is not the “purchase” (No in ACT 109), the image forming apparatus 100 terminates the processing. If it is determined that the input is the “purchase” (Yes in ACT 109), the image forming apparatus 100 transmits the commodity purchase instruction of the commodity displayed on the display 110 to the sales support server 400 (ACT 110). The sales support server 400 executes the commodity purchase processing (ACT 111). The sales support server 400 transmits the commodity movement instruction (for example, POS register 500) to the second communication apparatus 700 based on the commodity purchase processing (ACT 112). The sales support server 400 transmits the display instruction to the display device 600 (ACT 113). The display device 600 displays the reception destination of the commodity to the customer based on the display instruction (ACT 114).

If the customer arrives at the POS register 500, the POS register 500 executes the checkout processing of the commodity based on the operation of the store clerk (ACT 115). The POS register 500 transmits the result of the checkout processing to the POS server 300 (ACT 116). The POS server 300 updates the commodity information and the sales information based on the result of the checkout processing (ACT 117). In particular, the commodity information and the sales information include decreasing in the inventory number and addition in the sales amount.

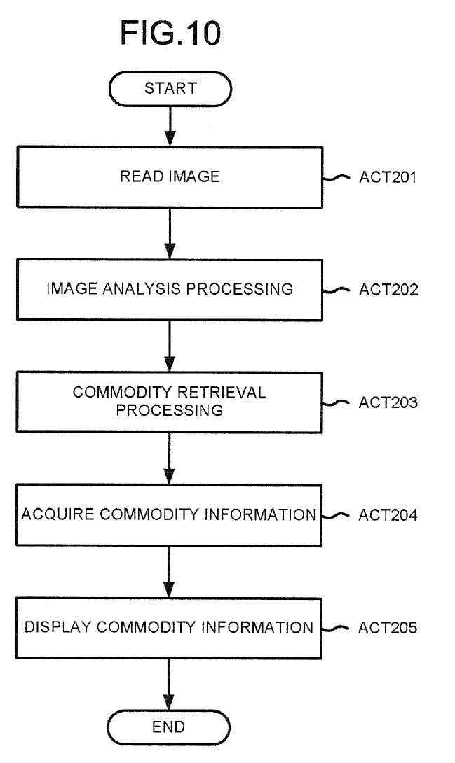

FIG. 10 is a flowchart illustrating a flow of the commodity retrieval processing according to the embodiment. The image reading section 190 of the image forming apparatus 100 reads the image information such as character strings, images and the like of the arranged commodity (ACT 201). The image analysis section 181 executes the OCR and the image analysis processing to the read image information (ACT 202). Based on the execution result of the OCR and the image analysis processing, the commodity retrieval section 182 executes the commodity retrieval processing via the network 900 (ACT 203). Based on the retrieval result of the commodity, the image forming apparatus 100 acquires the commodity information from the sales support server 400 (ACT 204). The display 110 of the image forming apparatus 100 displays the commodity information acquired from the sales support server 400 (ACT 205). At this time, the image forming apparatus 100 may send the commodity information to the first communication apparatus 200. If the first communication apparatus 200 receives the commodity information, the display section 205 displays the commodity information.

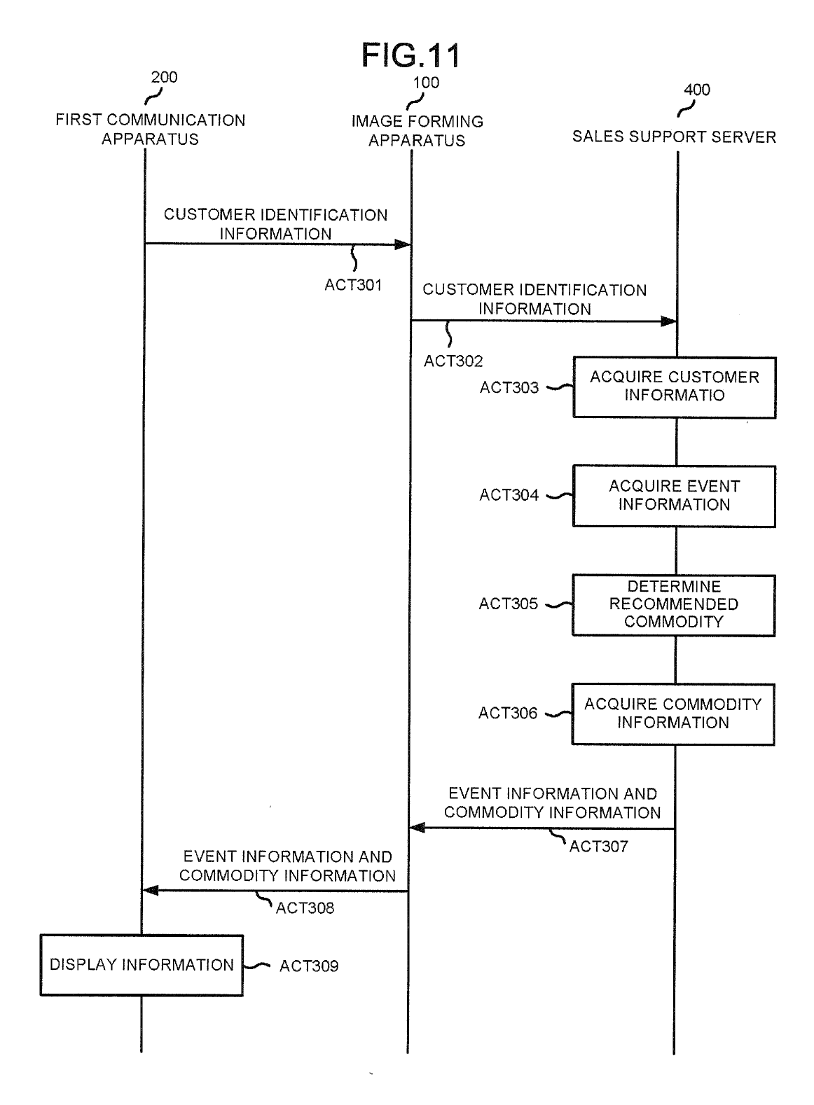

FIG. 11 is a sequence diagram illustrating a flow of an information delivery processing according to the embodiment. The first communication apparatus 200 starts the application for retail store in advance. The first communication apparatus 200 transmits the customer identification information to the image forming apparatus 100 if approaching the image forming apparatus 100 (ACT 301). The image forming apparatus 100 transmits the received customer identification information to the sales support server 400 (ACT 302). The sales support server 400 acquires the customer information from the customer information storage section 402 based on the customer identification information (ACT 303). The sales support server 400 acquires the event information from the event information storage section 404 (ACT 304). The sales support server 400 determines the commodity to be recommended to the customer based on the customer information (ACT 305). For example, in a case in which a discount is received if a commodity that is purchased last time is purchased again, the sales support server 400 determines the commodity as the recommended commodity. The sales support server 400 acquires the commodity information of the recommended commodity from the commodity information storage section 403 (ACT 306). The sales support server 400 transmits the event information and the commodity information to the image forming apparatus 100 (ACT 307). The image forming apparatus 100 transmits the event information and the commodity information to the first communication apparatus 200 (ACT 308). If the first communication apparatus 200 receives the event information and the commodity information, the display section 205 displays the event information and the commodity information (ACT 309).

With the sales support system 1 that is constituted in that way, the customer can purchase the commodity via the image forming apparatus 100. The customer can receive the purchased commodity at the register. Thus, there is no need for the customer to carry the purchased commodity in the retail store. Therefore, people who are difficult to carry the commodity in the retail store such as the elderly, the handicapped, pregnant women and parent with an infant can comfortably shop than ever, thereby improving service for customers.

The sales support system 1 of the embodiment may be constituted in such a manner that the control panel 120 can be operated if receiving the customer identification information from the first communication apparatus 200. With such a configuration, malicious third party can be prevented from instructing the purchase through operating the control panel 120.

The sales support system 1 of the embodiment may be constituted in such a manner that the control panel 120 can be operated if the non-contact reader section 170 reads the customer identification information from the IC card. With such a configuration, malicious third party can be prevented from instructing the purchase through operating the control panel 120.

The sales support system 1 of the embodiment may be constituted in such a manner that the purchase instruction is transmitted from the first communication apparatus 200 to the sales support server 400 by photographing the commodity or commodity tags in the retail store with the image capturing section 203. With such a configuration, the customer can shop freely and can receive the purchased commodity at the register without moving to the image forming apparatus 100. Therefore, the customer can comfortably shop than ever, thereby improving service for customers.

For evaluation displayed on the virtual space, the response by the customer may be inhibited. With such a configuration, it is possible to prevent the defamation between customers to be capable of maintaining public order in the virtual space.

The retail store may provide the value data to the customer according to the evaluation times and the evaluation points for commodity. For example, the discount may be set for the commodity subjected to the evaluation. With such a configuration, the evaluation by the customer becomes active, and it is possible to prompt the activation of the virtual space.

While certain embodiments have been described, these embodiments have been presented byway of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

The image forming apparatus 100 may be substituted for the other information processing apparatus which has a display for displaying information relating to a commodity.

What is claimed is:

1. An image forming apparatus, comprising:
a first communication section connected with a first communication apparatus used by a user who wants to purchase a commodity to be sold in a communicable manner, the first communication apparatus configured to provide a first purchase instruction for instructing purchase of the commodity;
a display section configured to display information relating to the commodity;
an operation section configured to receive a second purchase instruction for instructing purchase of a commodity displayed on the display section; and
a second communication section configured to transmit the first purchase instruction or the second purchase instruction to a sales support server instructing a store clerk that a commodity to which the first purchase instruction or the second purchase instruction is carried out by the user is conveyed to a predetermined position.

2. The image forming apparatus according to claim 1, wherein
in response to receipt of customer identification information by the first communication section from the first communication apparatus that stores the customer identification information, the operation section starts to receive the second purchase instruction.

3. The image forming apparatus according to claim 1, further comprising:
a non-contact reader configured to read customer identification information from an IC card for storing a customer identification information, wherein
if the non-contact reader reads the customer identification information from the IC card, the operation section starts to receive the second purchase instruction.

4. The image forming apparatus according to claim 1, further comprising:
an image reading section configured to read image information from a sheet on which information relating to the commodity is printed; and
a commodity retrieval section configured to retrieve the commodity based on the read image information to acquire commodity information of the retrieved commodity, wherein
the display section displays the commodity information.

5. The image forming apparatus according to claim 4, further comprising:
a printer section configured to form an image on the sheet based on the commodity information.

6. The image forming apparatus according to claim 4, wherein
the commodity retrieval section transmits the commodity information to the first communication apparatus.

7. The image forming apparatus according to claim 6, wherein
the commodity retrieval section acquires commodity information of a plurality of commodities in a case in which there is a plurality of retrieved commodities, and
the printer section aggregates a plurality of acquired commodity information to form an image on one sheet.

8. The image forming apparatus according to claim 1, wherein the operation section receives a second purchase instruction and the second communication section transmits the first purchase instruction or the second purchase instruction in a wireless manner.

9. A purchase support method, comprising:
receiving a first purchase instruction for instructing purchase of a commodity;
displaying information relating to the commodity;
receiving a second purchase instruction for instructing purchase of a commodity displayed; and
transmitting the first purchase instruction or the second purchase instruction to instruct a store clerk that a commodity to which the first purchase instruction or the second purchase instruction is carried out is conveyed to a predetermined position.

10. The purchase support method according to claim 9, wherein
in response to receiving of customer identification information from a storage of customer identification information, receiving the second purchase instruction is initiated.

11. The purchase support method according to claim 9, further comprising:
reading the customer identification information from an IC card for storing a customer identification information in a non-contact manner, wherein
if reading the customer identification information from the IC card, receiving the second purchase instruction is initiated.

12. The purchase support method according to claim 9, further comprising:
reading image information from a sheet on which information relating to the commodity is printed; and
retrieving the commodity based on the read image information to acquire commodity information of the retrieved commodity.

13. The purchase support method according to claim 12, further comprising:
forming an image on the sheet based on the commodity information.

14. The purchase support method according to claim 12, wherein
transmitting the commodity information to a user.

15. The purchase support method according to claim 9, wherein receiving the first purchase instruction, receiving the second purchase instruction, and transmitting the first purchase instruction or the second purchase instruction are conducted in a wireless manner.

16. The purchase support method according to claim 9, wherein
acquiring commodity information of a plurality of commodities in a case in which there is a plurality of retrieved commodities, and
aggregating a plurality of acquired commodity information to form an image on one sheet.

17. A sales support system comprising a first communication apparatus, an image forming apparatus, and a sales support server which are connected with each other via communication lines,
the first communication apparatus comprising:
an operation section configured to receive an operation by a user who wants to purchase a commodity for sale; and
a communication section configured to transmit a first purchase instruction for instructing purchase of the commodity to the image forming apparatus in response to the operation,
the image forming apparatus comprising:
a first communication section connected with the first communication apparatus in a communicable manner and configured to receive a first purchase instruction for instructing purchase of the commodity from the first communication apparatus;
a display section configured to display information relating to the commodity;
an operation section configured to receive a second purchase instruction for instructing purchase of a commodity displayed on the display section; and
a second communication section configured to transmit the first purchase instruction or the second purchase instruction to the sales support server, and
the sales support server comprising:
a communication section configured to transmit information indicating that the commodity to which the first purchase instruction or the second purchase instruction is carried out by the user is conveyed to a predetermined position to a second communication apparatus that is operated by a store clerk.

18. The sales support system according to claim 17, wherein
the sales support server further comprises:
a transmission section configured to transmit event data indicating an event to be held in a retail store which sells the commodity to the first communication apparatus.

19. The sales support system according to claim 17, wherein
the image forming apparatus further comprises:
an image reading section configured to read image information from a sheet on which information relating to the commodity is printed; and
a commodity retrieval section configured to retrieve the commodity based on the read image information to acquire commodity information of the retrieved commodity, wherein
the display section displays the commodity information.

20. The sales support system according to claim 17, further comprising:
a non-contact reader configured to read customer identification information from an IC card for storing a customer identification information, wherein
if the non-contact reader reads the customer identification information from the IC card, the operation section starts to receive the second purchase instruction.
